(19) United States
(12) Patent Application Publication
(10) Pub. No.: US 2026/0195074 A1
(43) Pub. Date: Jul. 9, 2026

(54) MEMORY EXPANDER, OPERATING METHOD OF MEMORY EXPANDER, AND COMPUTING SYSTEM

(71) Applicant: SAMSUNG ELECTRONICS CO., LTD., Suwon-si (KR)

(72) Inventor: Junbum PARK, Suwon-si (KR)

(73) Assignee: SAMSUNG ELECTRONICS CO., LTD., Suwon-si (KR)

(21) Appl. No.: 19/438,040

(22) Filed: Dec. 31, 2025

(30) Foreign Application Priority Data
Jan. 9, 2025 (KR) 10-2025-0003747
Apr. 3, 2025 (KR) 10-2025-0043607

(51) Int. Cl. G06F 3/06

(52) U.S. Cl. CPC G06F 3/0659; G06F 3/0604; G06F 3/0679

(57) ABSTRACT

A memory expander includes a memory controller configured to control a memory device; and a memory interface configured to receive a packet from a host device, control a plurality of layers to sequentially process the packet and transmit a command included in the packet to the memory controller. The memory interface includes a snooping circuit configured to, based on the packet including a read command, transmit the read command in the packet to the memory controller by bypassing at least some of the plurality of layers.

### CROSS-REFERENCE TO RELATED APPLICATIONS

This application is based on and claims priority under 35 U.S.C. § 119 to Korean Patent Application Nos. 10-2025-0003747, filed on January 9, 2025 and 10-2025-0043607, filed on April 3, 2025, in the Korean Intellectual Property Office, the disclosures of which are incorporated by reference herein in their entireties.

### BACKGROUND

The present disclosure relates to a memory expander for processing packets received from a host device.

As technologies, such as artificial intelligence (AI), big data, and edge computing have advanced, demand for devices to quickly process large amounts of data has increased. To meet the needs, advanced interconnect standard technologies are being developed to support high-speed communication between host devices, such as Compute Express Link (CXL) and memory devices.

### SUMMARY

One or more embodiments provide a memory expander capable of processing a read command received from a host device with a low delay time.

According to an aspect of an embodiment, there is provided a memory expander including: a memory controller configured to control a memory device; and a memory interface configured to receive a packet from a host device, control a plurality of layers to sequentially process the packet and transmit a command included in the packet to the memory controller. The memory interface includes a snooping circuit configured to, based on the packet including a read command, transmit the read command in the packet to the memory controller by bypassing at least some of the plurality of layers.

According to another aspect of an embodiment, there is provided an operating method of a memory expander including a memory controller and a memory interface, the operating method including: receiving a packet from a host device through the memory interface; monitoring the packet through a snooping circuit included in the memory interface; identifying whether the packet includes a read command or a write command through the snooping circuit; and based on identifying the packet includes the read command or the write command, transmitting the read command or the write command to a hazard filter included in the memory interface through the snooping circuit.

According to another aspect of an embodiment, there is provided a computing system including: a host device; a memory device; and a memory expander including a memory interface configured to receive a packet from the host device and a memory controller configured to control the memory device based on a command included in the packet. The memory interface is configured to control a plurality of layers to sequentially process the packet, and includes: a snooping circuit transmitting a read command or a write command included in the packet by bypassing at least some of the plurality of layers; and a hazard filter circuit configured to identify, based on the read command being received from the snooping circuit, whether to transmit the read command received from the snooping circuit to the memory controller, based on the write command received from the snooping circuit being stored in a write area table.

### BRIEF DESCRIPTION OF DRAWINGS

The above and other aspects and features of the present disclosure will be more clearly understood from the following description of embodiments, taken in conjunction with the accompanying drawings, in which:

FIG. 1 is a block diagram illustrating a computing system according to an embodiment;

FIG. 2 is a block diagram illustrating a detailed structure of a memory interface included in a memory expander, according to an embodiment;

FIG. 3 is a diagram illustrating an example of a packet received by a memory expander, according to an embodiment;

FIG. 4 is a diagram illustrating an operation of a hazard filter when a write command is received from a snooping circuit, according to an embodiment;

FIG. 5 is a diagram illustrating an operation of a hazard filter when write commands are received from a plurality of layers, according to an embodiment;

FIG. 6 is a diagram illustrating an operation of a hazard filter when a read command that overlaps a write command stored in a write area table is received from a snooping circuit, according to an embodiment;

FIG. 7 is a diagram illustrating an operation of a hazard filter when a read command that does not overlap a write command stored in a write area table is received from a snooping circuit, according to an embodiment;

FIG. 8 is a diagram illustrating an operation of a hazard filter when read commands determined to overlap a write command are from a plurality of layers, according to an embodiment;

FIG. 9 is a diagram illustrating an operation of a hazard filter when read commands determined not to overlap a write command are from a plurality of layers, according to an embodiment;

FIG. 10 is a diagram illustrating an operation of a hazard filter when data is received from a memory device, according to an embodiment;

FIG. 11 is a flowchart illustrating an operating method of a snooping circuit included in a memory interface of a memory expander, according to an embodiment;

FIG. 12 is a flowchart illustrating a method by which a snooping device determines whether a packet includes a read command or a write command, according to an embodiment;

FIG. 13 is a flowchart illustrating an operating method when a hazard filter included in a memory interface of a memory expander receives a write command from a snooping circuit, according to an embodiment;

FIG. 14 is a flowchart illustrating an operating method when a hazard filter included in a memory interface of a memory expander receives a read command from a snooping circuit, according to an embodiment;

FIG. 15 is a flowchart illustrating an operating method when a hazard filter included in a memory interface of a memory expander receives write commands from a plurality of layers, according to an embodiment; and

FIG. 16 is a flowchart illustrating an operating method when a hazard filter included in a memory interface of a memory expander receives read commands from a plurality of layers, according to an embodiment.

### DETAILED DESCRIPTION

Hereinafter, embodiments are described in detail with reference to the attached drawings. Embodiments described herein are provided as examples, and thus, the present disclosure is not limited thereto, and may be realized in various other forms. Each embodiment provided in the following description is not excluded from being associated with one or more features of another example or another embodiment also provided herein or not provided herein but consistent with the present disclosure. Herein, like reference numerals refer to like elements.

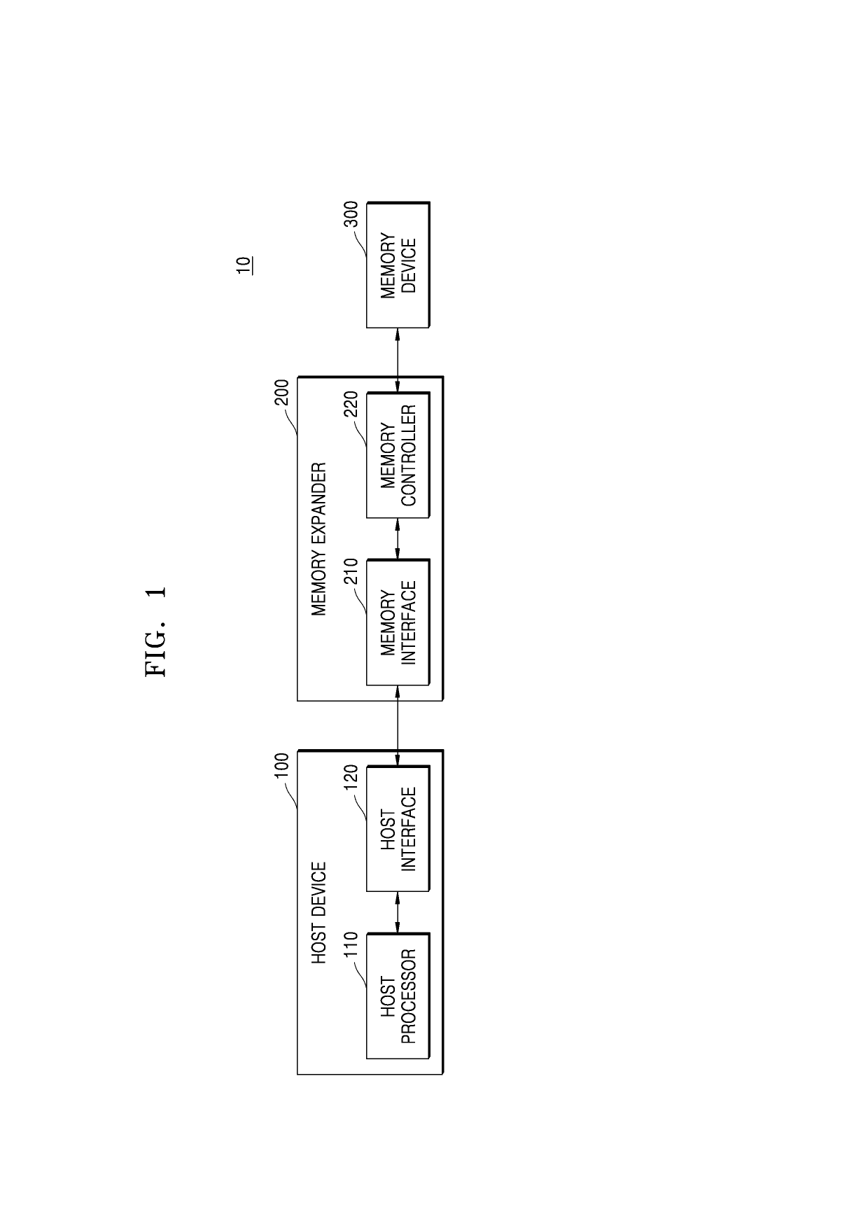

FIG. 1 is a block diagram illustrating a computing system 10 according to an embodiment.

Referring to FIG. 1, the computing system 10 according to an embodiment may include a host device 100, a memory expander 200, and a memory device 300.

In an embodiment, the computing system 10 may be implemented as a personal computer (PC), a data server, an ultra-mobile PC (UMPC), a workstation, a netbook, a network-attached storage (NAS), a smart television, an Internet of Things (IoT) device, an automobile, or a portable electronic device. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, etc.

The host device 100 may control the overall operation of the computing system 10. In an embodiment, the host device 100 may be, or include, a processor core, such as a central processing unit (CPU) or an application processor (AP), or a computing node connected via a network configured to control the computing system 10.

The host device 100 may include a host processor 110 and a host interface 120.

The host processor 110 may process operations related to the overall operation of the host device 100. The host processor 110 may store data in the memory device 300 through the memory expander 200, or read data stored in the memory device 300 through the memory expander 200.

The host interface 120 may be connected to the memory expander 200 and may manage data transfer between the host device 100 and the memory expander 200. The host interface 120 may communicate with the memory expander 200 through various types of interfaces. For example, the host interface 120 may communicate with the memory expander 200 through an interface that supports a Compute Express Link (CXL) protocol.

The host interface 120 may transmit a packet to the memory expander 200. The packet may include a variety of information. In an embodiment, the packet may include a read command or a write command. The host interface 120 may communicate with the memory expander 200 by using the CXL protocol, and a packet may be referred to as a flit (flow control unit).

In an embodiment, the memory expander 200 may include a memory interface (e.g., memory interface circuit) 210 and a memory controller (e.g., memory control circuit) 220.

The memory interface 210 may be connected to the host device 100. In an embodiment, the memory interface 210 may be connected to the host interface 120 of the host device 100.

The memory interface 210 may manage data transfer between the memory expander 200 and the host device 100. The memory interface 210 may communicate with the memory expander 200 through the same type of interface as that of the host interface 120. For example, when the host interface 120 uses an interface that supports the CXL protocol, the memory interface 210 may communicate with the host device 100 through the interface that supports the CXL protocol.

The memory interface 210 may receive packets from the host device 100. The memory interface 210 may transmit a command included in a packet to the memory controller 220. For example, the memory interface 210 may transmit a read command or a write command included in a packet to the memory controller 220.

The memory interface 210 may include a plurality of layers that process packets sequentially. The plurality of layers may sequentially process packets to obtain read commands or write commands included in the packets, and transmit the read commands or write commands included in the packets to the memory controller 220. Here, when the memory interface 210 sequentially processes the packets through the plurality of layers, time is required for the packets to pass through the plurality of layers, and as a result, the delay time in processing packets received from the host device 100 may increase.

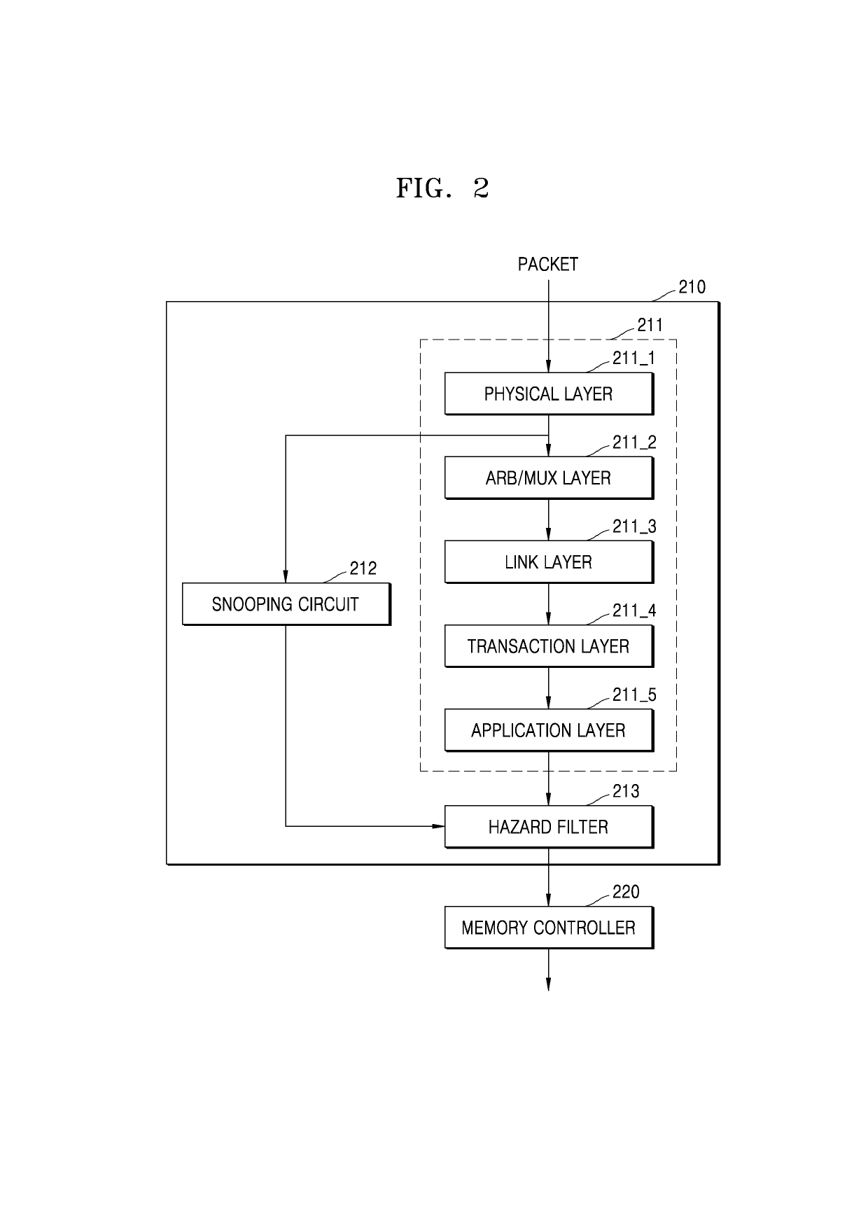

In an embodiment, the memory interface 210 may include a snooping circuit. If a packet includes a read command, the snooping circuit may identify the read command and transmit the read command included in the packet to the memory controller 220 by bypassing at least some of the plurality of layers. In this manner, by transmitting the read command to the memory controller 220 by bypassing at least some of the plurality of layers, it is possible to process the read command received from the host device 100 with a low delay time. For example, for each of the at least one of the plurality layers that is bypassed, the delay time may be decreased. A configuration and operation of the memory interface 210 are described below with reference to FIG. 2 and the following drawings.

The memory controller 220 may control the memory device 300. The memory controller 220 may control the memory device 300 based on a command received from the memory interface 210. For example, the memory controller 220 may read data from the memory device 300 based on a read command received from the memory interface 210. In addition, the memory controller 220 may write data to the memory device 300 based on a write command received from the memory interface 210.

The memory device 300 may operate based on a command received from the memory controller 220 of the memory expander 200. For example, the memory device 300 may transmit data stored therein to the memory controller 220, based on a read command received from the memory controller 220. In addition, the memory device 300 may store write data internally based on a write command received from the memory controller 220.

In an embodiment, the memory device 300 may be a device attached memory. The memory device 300 may include volatile memory, such as static random access memory (SRAM), dynamic random access memory (DRAM), etc. However, embodiments are not limited thereto, and the memory device 300 may include nonvolatile memory, such as flash memory, phase-change random access memory (PRAM), magnetic random access memory (MRAM), and ferroelectric random access memory (FeRAM).

FIG. 2 is a block diagram illustrating a detailed structure of the memory interface 210 included in the memory expander 200, according to an embodiment.

Referring to FIG. 2, the memory interface 210 included in the memory expander 200 according to an embodiment may include a plurality of layers 211, a snooping circuit 212, and a hazard filter (e.g., a hazard filter circuit) 213. For example, the memory interface 210 may include circuitry, including controllers, drivers, buffers, processors, transmitters and receivers, configured to implement the plurality of layers 211, the snooping circuit 212, and the hazard filter 213.

The plurality of layers 211 may sequentially process packets received from the host device 100. When the memory interface 210 communicates with the host interface 120 by using the CXL protocol, the plurality of layers 211 may include first to fifth layers, and the first layer may be a physical layer 211_1, the second layer may be an ARB/MUX layer 211_2, the third layer may be a link layer 211_3, the fourth layer may be a transaction layer 211_4, and the fifth layer may be an application layer 211_5.

The physical layer 211_1 may provide a physical transmission path for packet transmission between the memory interface 210 and the host device 100. The physical layer 211_1 may perform decoding on packets received from the host device 100. The physical layer 211_1 may convert an analog packet received from the host device 100 into a digital format.

The ARB/MUX layer 211_2 may route a packet received from the physical layer 211_1 to one of an input/output link layer and a cache memory link layer included in the link layer 211_3 depending on a protocol type of the packet. In addition, the ARB/MUX layer 211_2 may sequentially transmit packets received from the input/output link layer and the cache memory link layer included in the link layer 211_3 to the physical layer 211_1.

The link layer 211_3 may perform an integrity verification operation on the packets received from the ARB/MUX layer 211_2. The link layer 211_3 may perform an error detection operation by using cyclic redundancy check (CRC) bits included in a packet.

The transaction layer 211_4 may perform operations, such as message format processing, transaction request response management, and address mapping for packets received from the link layer 211_3.

The application layer 211_5 may manage commands that need to be transmitted to the memory controller 220.

In this manner, when the memory interface 210 sequentially processes packets received from the host device 100 through the plurality of layers 211, a delay time may occur as processing is performed for each of the plurality of layers 211.

In an embodiment, the memory interface 210 may include the snooping circuit 212. The snooping circuit 212 may monitor a packet received from the host device 100. Here, the snooping circuit 212 may monitor a packet that has passed through the physical layer 211_1 in which decoding is performed on the packet.

The snooping circuit 212 may monitor the packet to determine whether the packet includes a read command or a write command. For example, to determine whether the packet includes a read command or a write command, the snooping circuit 212 may monitor the protocol ID field, the packet type field, and the slot format field included in the packet.

The protocol ID field may indicate what protocol the data transmitted through the packet uses. Here, if the protocol ID field indicates that the packet is a memory packet related to access to the memory device 300, the packet may include a read command or a write command.

If the packet is a memory packet, the packet type field may indicate whether the packet is a protocol packet related to data input/output or a control packet related to data transmission control. If the packet type field indicates that the packet is a protocol packet, the packet may include a read command or a write command.

The slot format field may indicate whether a slot included in the packet is for a read command or a write command. If the slot format field indicates a read command, the packet may include a read command. In addition, if the slot format field indicates a write command, the packet may include a write command.

The snooping circuit 212 may determine that the packet includes a read command if the protocol ID field indicates that the packet is a memory packet, the packet type field indicates that the packet is a protocol packet, and the slot format field indicates a read command. In addition, the snooping circuit 212 may determine that the packet includes a write command if the protocol ID field indicates that the packet is a memory packet, the packet type field indicates that the packet is a protocol packet, and the slot format field indicates a write command.

The snooping circuit 212 may determine in parallel whether the protocol ID field indicates that the packet is a memory packet, whether the packet type field indicates that the packet is a protocol packet, and whether the slot format field indicates a read command. In this manner, the snooping circuit 212 may minimize the delay time occurring in the snooping circuit 212 by simultaneously determining whether the protocol ID field indicates that the packet is a memory packet, whether the packet type field indicates that the packet is a protocol packet, and whether the slot format field indicates a read command.

The snooping circuit 212 may transmit the read command or write command to the hazard filter 213 if the packet includes a read command or a write command. That is, the snooping circuit 212 may transmit a read command or a write command to the hazard filter 213 by bypassing at least some of the plurality of layers 211. As shown in FIG. 2, the snooping circuit 212 may transmit a read command or a write command to the hazard filter 213 by bypassing the ARB/MUX layer 211_2, the link layer 211_3, the transaction layer 211_4, and the application layer 211_5. In this manner, by transmitting the read command included in the packet to the hazard filter 213 by bypassing at least some of the plurality of layers 211, the read command received from the host device 100 may be processed with a low delay time.

The snooping circuit 212 may transmit an address and size corresponding to the read command, together with the read command, to the hazard filter 213. In addition, the snooping circuit 212 may transmit an address and size corresponding to the write command, together with the write command, to the hazard filter 213. Here, the snooping circuit 212 may not transmit write data corresponding to the write command to the hazard filter 213. Accordingly, the write data corresponding to the write command may be transmitted to the hazard filter 213 through the plurality of layers 211.

The hazard filter 213 may receive a read command or a write command from the snooping circuit 212.

When the hazard filter 213 receives a write command from the snooping circuit 212, the hazard filter 213 may store the write command received from the snooping circuit 212 in a write area table. The write area table may store the write command received through the snooping circuit 212. The write area table may store validity information, a tag, an address, and a size. The validity information may indicate whether the write command recorded in the write area table is valid. The tag may be a unique identifier for the write command. The address may indicate a start address of an address in which the write data is to be written within the memory device 300. The size may indicate the size of the write data corresponding to the write command.

Because the write data corresponding to the write command is transmitted to the hazard filter 213 through the plurality of layers 211, the write command received through the snooping circuit 212 may not yet be transmitted to the memory controller 220. Accordingly, the hazard filter 213 may store and manage the write command (which corresponds to the write data being processed by the plurality of layers 211) received from the snooping circuit 212 but not yet transmitted to the memory controller 220 in the write area table.

When the hazard filter 213 receives a write command from the plurality of layers 211, the hazard filter 213 may delete a write command corresponding to the write command received from the plurality of layers 211 from the write area table. The hazard filter 213 may compare a tag of the write command received from the plurality of layers 211 with a tag stored in the write area table, and delete a write command corresponding to a tag identical to the tag of the write command received from the plurality of layers 211. Here, the hazard filter 213 may delete the write command corresponding to the tag identical to the tag of the write command received from the plurality of layers 211 from the write area table by changing the validity information.

Because the write data corresponding to the write command is transmitted to the hazard filter 213 through the plurality of layers 211, the write command received through the plurality of layers 211 may be transmitted to the memory controller 220. Accordingly, the hazard filter 213 may transmit the write command to the memory controller 220 upon receiving the write command through the plurality of layers 211 and delete the transmitted write command from the write area table. In this manner, the write area table may store the write command received from the snooping circuit 212 but not yet transmitted to the memory controller 220.

When the hazard filter 213 receives a read command from the snooping circuit 212, the hazard filter 213 may determine whether to transmit the read command received from the snooping circuit 212 to the memory controller 220 based on the write area table.

In an embodiment, when the hazard filter 213 receives a read command from the snooping circuit 212, the hazard filter 213 may compare an address and size corresponding to the read command received from the snooping circuit 212 with an address and size corresponding to the write command stored in the write area table. The hazard filter 213 may determine whether the read command received from the snooping circuit 212 overlaps the write command stored in the write area table. That is, the snooping circuit 212 may determine whether an area from which data is to be read in the memory device 300 according to a read command received from the snooping circuit 212 overlaps an area to which data is to be written in the memory device 300 according to a write command stored in the write area table.

Here, if the read command received from the snooping circuit 212 overlaps the write command stored in the write area table, the hazard filter 213 may have received a read command for the area to which write data is to be written according to the write command that has not yet been performed. Therefore, if the read command received from the snooping circuit 212 overlaps the write command stored in the write area table, the hazard filter 213 may not transmit the read command received from the snooping circuit 212 to the memory controller 220. In this manner, the hazard filter 213 may prevent a read after write (RAW) error by using the write area table.

Conversely, if the read command received from the snooping circuit 212 does not overlap the write command stored in the write area table, the hazard filter 213 may transmit the read command received from the snooping circuit 212 to the memory controller 220.

The hazard filter 213 may store the read command received from the snooping circuit 212 in a read mark table. The read mark table may store the read command received through the snooping circuit 212. The read mark table may store validity information, a tag, and a mark. The validity information may indicate whether the read command recorded in the read mark table is valid. The tag may be a unique identifier for a read command. The mark may indicate whether the read command has been transmitted to the memory controller 220.

The hazard filter 213 may store as a mark in the read mark table whether the read command received from the snooping circuit 212 has been transmitted to the memory controller 220.

When the hazard filter 213 receives a read command from the plurality of layers 211, the hazard filter 213 may compare the read command received from the plurality of layers 211 with the read command stored in the read mark table to determine whether the read command received from the plurality of layers 211 has been transmitted to the memory controller 220. The hazard filter 213 may compare a tag of the read command received from the plurality of layers 211 with a tag stored in the read mark table and determine whether the read command received from the plurality of layers 211 has been transmitted to the memory controller 220, based on the mark corresponding to the same tag.

If it is determined that the read command received from the plurality of layers 211 has not been transmitted to the memory controller 220, the hazard filter 213 may transmit the read command received from the plurality of layers 211 to the memory controller 220. That is, if the read command received from the snooping circuit 212 overlaps the write command stored in the write area table and is not transmitted to the memory controller 220, the hazard filter 213 may transmit the same read command to the memory controller 220 when the same read command is received from the plurality of layers 211. In this manner, the hazard filter 213 may process the read command without missing by using the read mark table.

The hazard filter 213 may receive error information on the read command or the write command received from the plurality of layers 211 and the snooping circuit 212. The error information may indicate that the read command or write command received from the snooping circuit 212 is incorrect data. The hazard filter 213 may not process the read command or the write command corresponding to the error information, based on the error information received from the plurality of layers 211. In addition, the hazard filter 213 may delete the write command of the write area table or the read command of the read mark table corresponding to the error information.

As described above, by using the memory expander 200 according to embodiments, the snooping circuit 212 may transmit the read command included in the packet to the memory controller 220 by bypassing at least some of the plurality of layers 211, thereby processing the read command received from the host device 100 with a low delay time. In addition, the hazard filter 213 may prevent a RAW error by not transmitting, to the memory controller 220, a read command for an area that overlaps a write command that has not yet been performed among the read commands received from the snooping circuit 212.

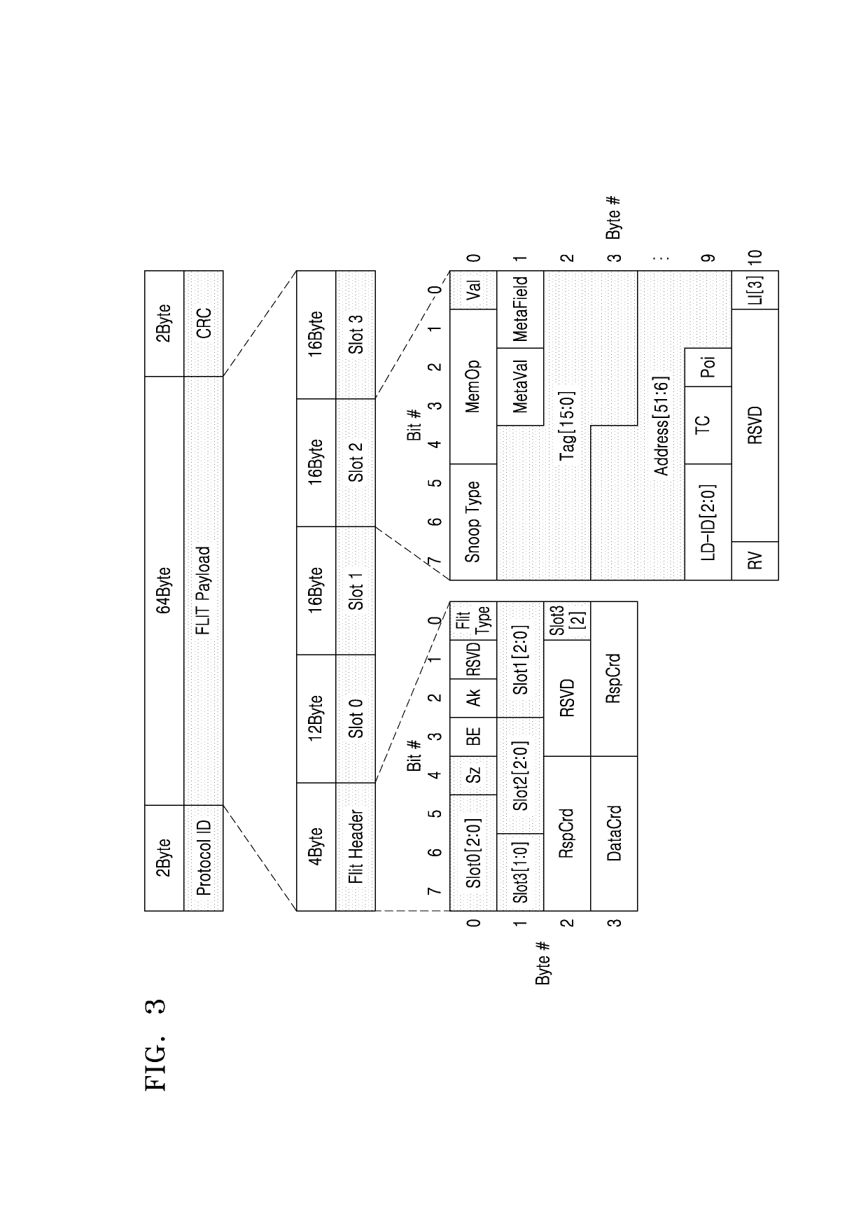

FIG. 3 is a diagram illustrating an example of a packet received by the memory expander 200 according to an embodiment.

Referring to FIG. 3, when the memory interface 210 communicates with the host interface 120 by using the CXL protocol, an example of a flit, which is a packet transmitted by the host interface 120 to the memory interface 210, may be checked.

Referring to FIG. 3, a flit may have a fixed size of 68 bytes. The flit may include a 2-byte protocol ID field, a 64-byte flit payload field, and a 2-byte CRC field.

The protocol ID field may indicate which protocol the data being transmitted through the flit is using. The snooping circuit 212 may determine whether a flit may include a read command or a write command by determining whether the protocol ID field indicates that the flit is a memory flit.

The flit payload field may include a flit header field of 4 bytes, a slot 0 field of 12 bytes, a slot 1 field of 16 bytes, a slot 2 field of 16 bytes, and a slot 3 field of 16 bytes.

The flit header field may include a 1-bit flit type field and may include slot format fields, such as a 3-bit slot 0 format field, a 3-bit slot 1 format field, a 3-bit slot 2 format field, and a 3-bit slot 3 format field.

The flit type field may indicate whether the flit is a protocol flit, which involves input/output of data, or a control flit, which involves controlling the transmission of data. By determining whether the flit type field indicates that the flit is a protocol flit, the snooping circuit 212 may determine whether a flit may include a read command or a write command.

The slot format field may indicate whether a slot included in the flit is for a read command or a write command. Here, by determining whether the slot format field indicates a read command, whether a flit may include a read command may be determined. In addition, by determining whether the slot format field indicates a write command, whether a flit may include a write command may be determined.

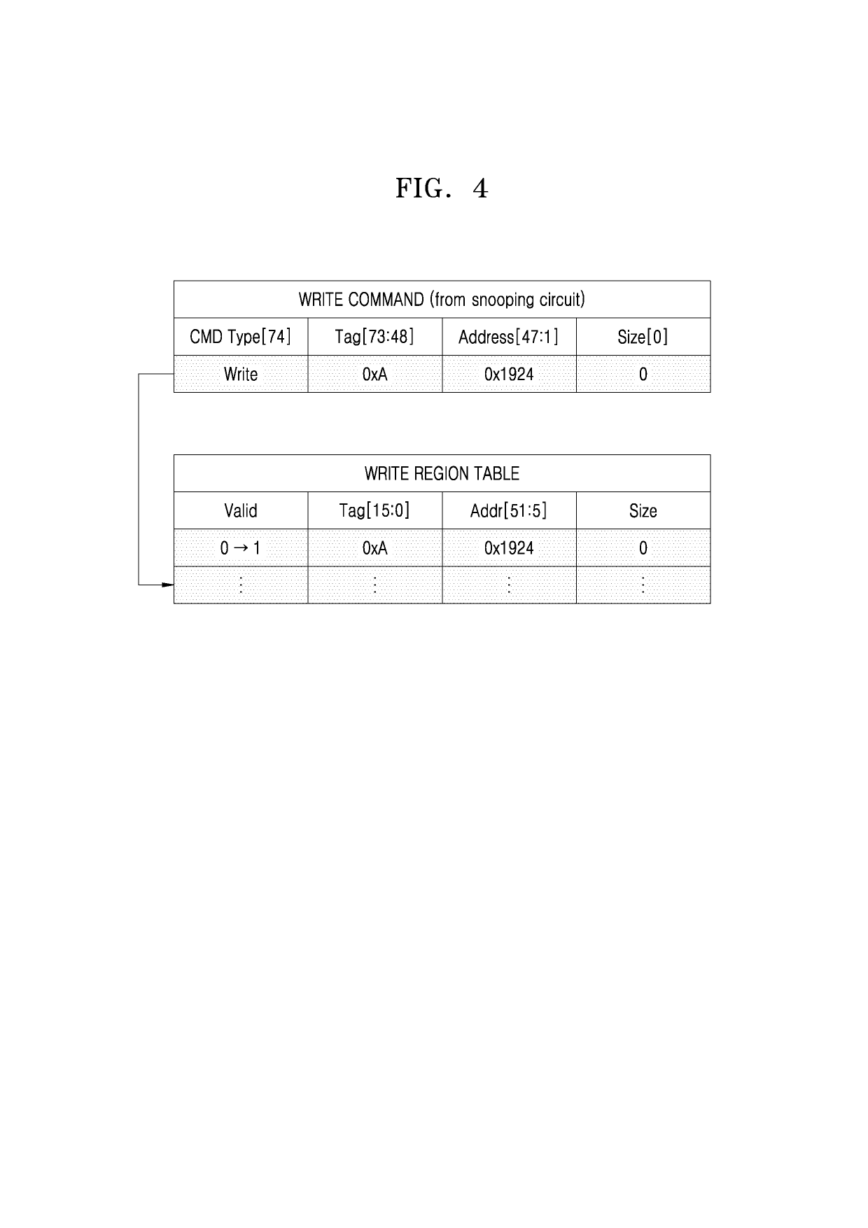

FIG. 4 is a diagram illustrating an operation of the hazard filter 213 when a write command is received from the snooping circuit 212, according to an embodiment.

Referring to FIG. 4, an example of a write command received from the snooping circuit 212 and the write area table stored in the hazard filter 213 is illustrated.

The write command received from the snooping circuit 212 may include a type, a tag, an address, and a size. The type of the write command may indicate that the command is a write command. The tag of the write command may indicate a unique identifier for the write command. The address of the write command may indicate an address in which write data corresponding to the write command is to be written. The size of the write command may indicate the size of the write data corresponding to the write command.

Referring to FIG. 4, the tag of the write command may have a value of 0xA, the address of the write command may have a value of 0x1924, and the size of the write command may have a value of 0. Here, based on the value of the size of the write command being 0, it may be determined that the size of the write data is 32 bytes. In addition, the value of the size of the write command may be 1 to indicate that the size of the write data is 64 bytes.

When the hazard filter 213 receives the write command from the snooping circuit 212, the hazard filter 213 may store the write command received from the snooping circuit 212 in the write area table. The write area table may store validity information, tags, addresses, and sizes.

Referring to FIG. 4, the hazard filter 213 may change the value of the validity information from 0 to 1 as the write command is stored. Here, if the value of the validity information is 1, it may indicate that the write command recorded in the corresponding row is valid. In addition, if the value of the validity information is 0, it may indicate that the write command recorded in the corresponding row is invalid.

The hazard filter 213 may store the tag, address and size included in the write command as the tag, address and size of the write area table. Referring to FIG. 4, the value of the tag of the write command, 0xA, may be stored in a tag column of the write area table, the value of the address of the write command, 0x1924, may be stored in the address column of the write area table, and the value of the size of the write command, 0, may be stored in the size column of the write area table.

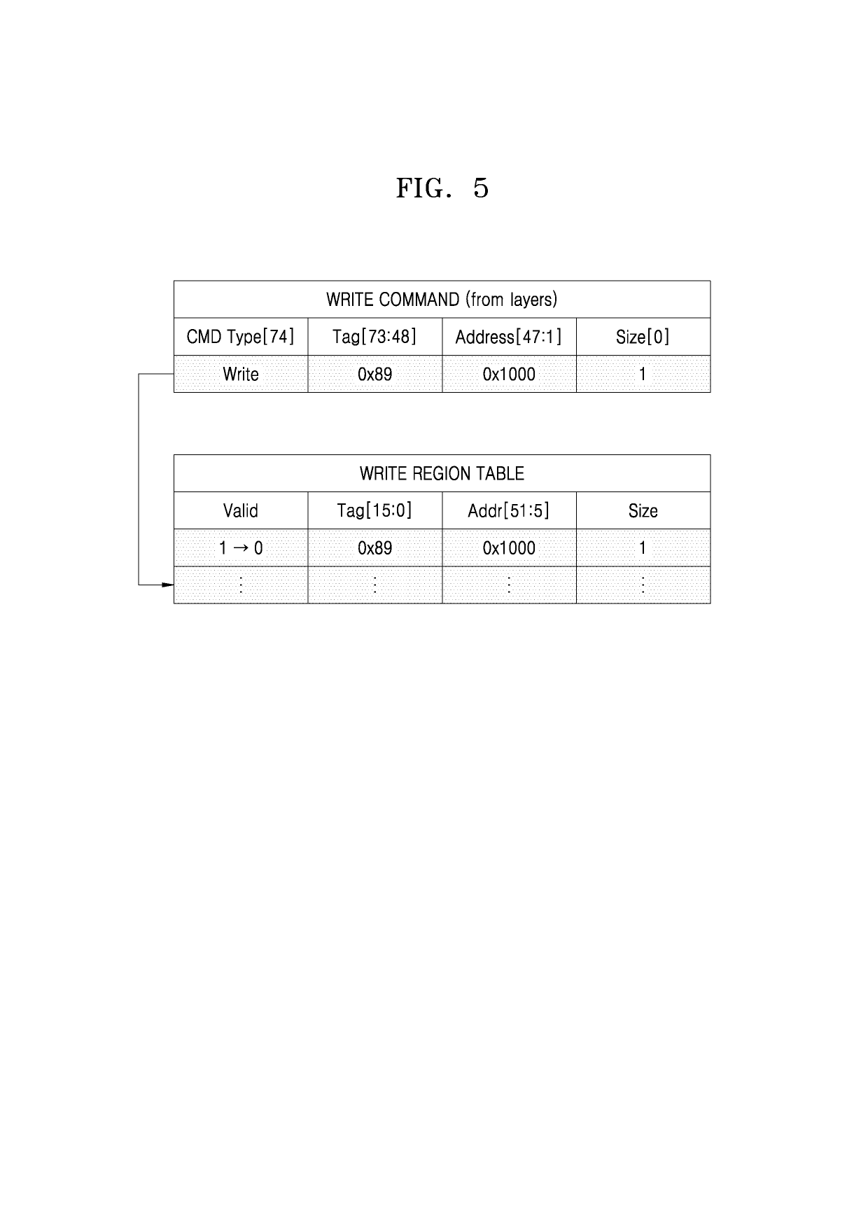

FIG. 5 is a diagram illustrating an operation of the hazard filter 213 when a write command is received from the plurality of layers 211, according to an embodiment.

Referring to FIG. 5, an example of a write command received from the plurality of layers 211 and the write area table stored in the hazard filter 213 is illustrated.

Referring to FIG. 5, the tag of the write command may have a value of 0x89, the address of the write command may have a value of 0x1000, and the size of the write command may have a value of 1.

When the hazard filter 213 receives a write command from the plurality of layers 211, the hazard filter 213 may delete the write command corresponding to the write command received from the plurality of layers 211 from the write area table.

Referring to FIG. 5, the hazard filter 213 may search the write area table for a write command having a tag identical to 0x89, which is the tag of the write command received from the plurality of layers 211. Here, the tag is a unique identifier for the write command, so if the tag is the same, the address and size may be the same.

The hazard filter 213 may delete a write command having a tag identical to 0x89, which is the tag of the write command received from the plurality of layers 211, from the write area table. Here, the hazard filter 213 may delete the write command with the tag 0x89 from the write area table by changing the value of the validity bit corresponding to the same tag 0x89 as the write command received from the plurality of layers 211 from 1 to 0.

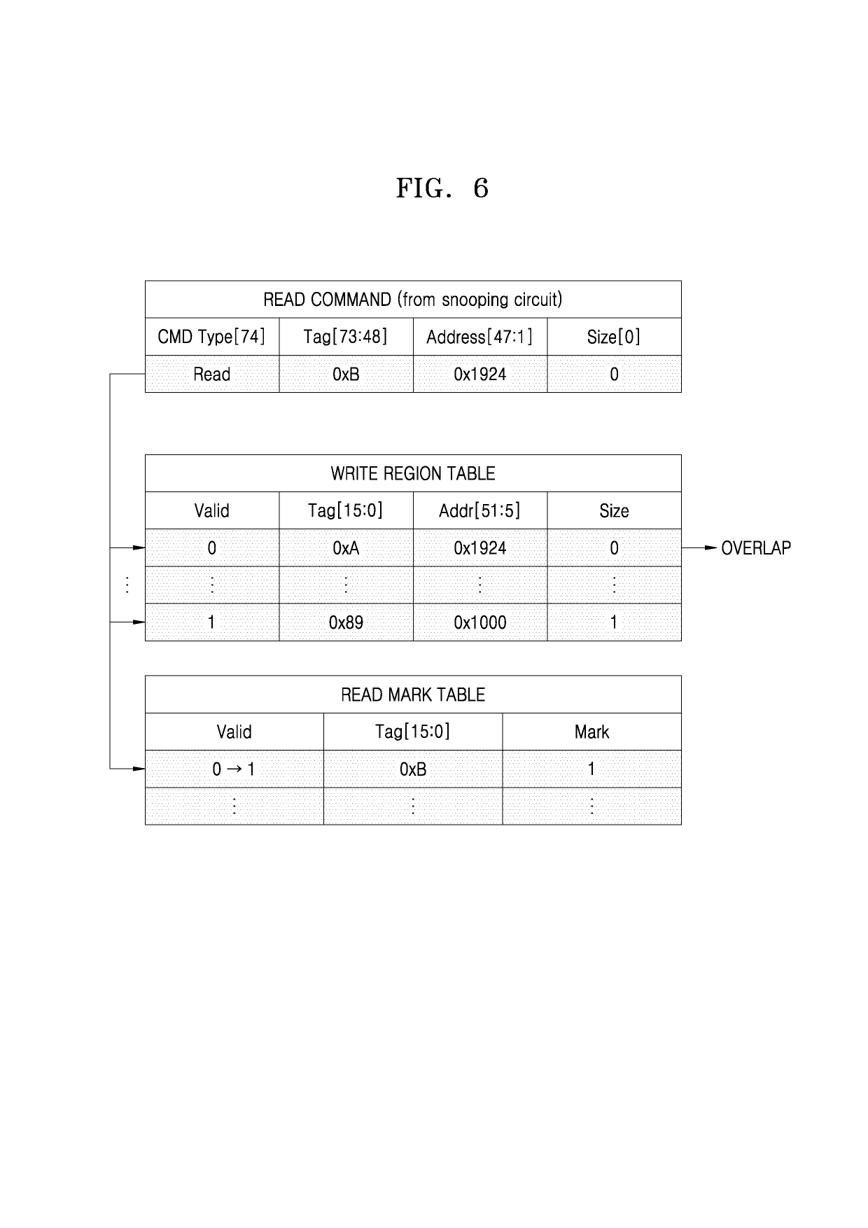

FIG. 6 is a diagram illustrating an operation of the hazard filter 213 when the hazard filter 213 receives a read command that overlaps a write command stored in the write area table from the snooping circuit 212, according to an embodiment.

Referring to FIG. 6, an example of a read command received from the snooping circuit 212 and the write area table and the read mark table stored in the hazard filter 213 is illustrated.

The read command received from the snooping circuit 212 may include a type, a tag, an address, and a size. The type of the read command may indicate that the command is a read command. The tag of the read command may indicate a unique identifier for the read command. The address of the read command may indicate an address in which the read data corresponding to the read command is stored. The size of the read command may indicate the size of the read data corresponding to the read command.

As shown in FIG. 6, the tag of the read command may have a value of 0xB, the address of the read command may have a value of 0x1924, and the size of the read command may have a value of 0.

When the hazard filter 213 receives the read command from the snooping circuit 212, the hazard filter 213 may determine whether to transmit the read command received from the snooping circuit 212 to the memory controller 220, based on the write area table.

As shown in FIG. 6, the hazard filter 213 may compare the address 0x1924 and the size 0 corresponding to the read command received from the snooping circuit 212 with the address and the size corresponding to the write command stored in the write area table. Here, because the address of the write command with the tag 0xA is 0x1924 and the size is 0, the hazard filter 213 may determine that the write command with the tag 0xA overlaps the read command received from the snooping circuit 212. Because the read command received from the snooping circuit 212 overlaps the write command stored in the write area table, the hazard filter 213 may not transmit the read command received from the snooping circuit 212 to the memory controller 220.

The hazard filter 213 may store the read command received from the snooping circuit 212 in the read mark table. The read mark table may store validity information, tags, and marks.

As shown in FIG. 6, the hazard filter 213 may change the value of the validity information from 0 to 1 as the read command is stored. Here, if the value of the validity information is 1, it may indicate that the read command recorded in the corresponding row is valid. In addition, if the value of the validity information is 0, it may indicate that the read command recorded in the corresponding row is invalid.

The hazard filter 213 may store the tag included in the read command as a tag in the read mark table. As shown in FIG. 6, the value of the tag of the read command, 0xB, may be stored in the tag column of the read mark table.

The hazard filter 213 may store as a mark in the read mark table whether the read command received from the snooping circuit 212 has been transmitted to the memory controller 220. With reference to FIG. 6, the value of 1 indicating that the read command received from the snooping circuit 212 was not transmitted to the memory controller 220 may be stored in the mark column of the read mark table. In addition, if the mark value of the read mark table is 0, it may indicate that the read command received from the snooping circuit 212 has been transmitted to the memory controller 220.

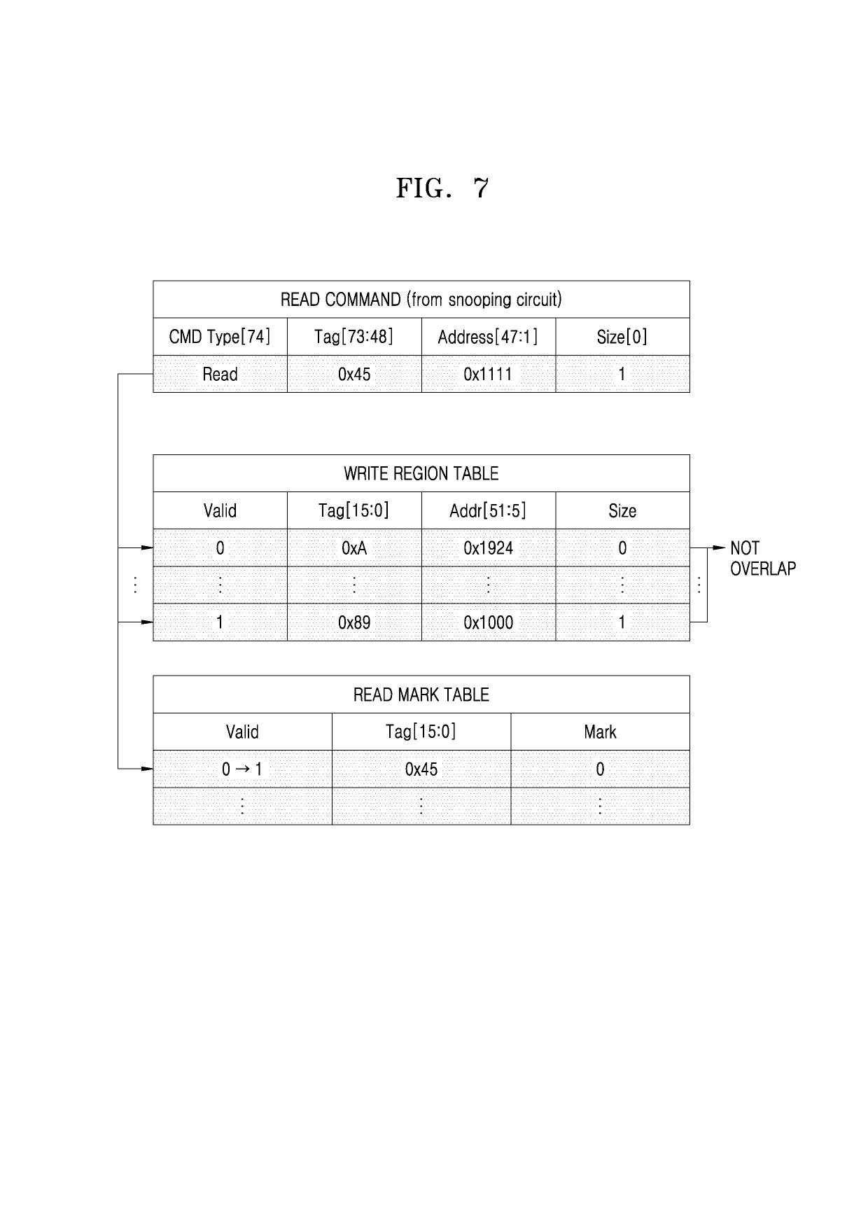

FIG. 7 is a diagram illustrating an operation of the hazard filter 213 when the hazard filter 213 receives a read command that does not overlap a write command stored in the write area table from the snooping circuit 212, according to an embodiment.

Referring to FIG. 7, an example of a read command received from the snooping circuit 212 and the write area table and the read mark table stored in the hazard filter 213 is illustrated.

Referring to FIG. 7, the tag of the read command may have a value of 0x45, the address of the read command may have a value of 0x1111, and the size of the read command may have a value of 1.

When the hazard filter 213 receives a read command from the snooping circuit 212, the hazard filter 213 may determine whether to transmit the read command received from the snooping circuit 212 to the memory controller 220, based on the write area table.

Referring to FIG. 7, the hazard filter 213 may compare the address 0x1111 and the size 1 corresponding to the read command received from the snooping circuit 212 with the address and the size corresponding to the write command stored in the write area table. Here, the hazard filter 213 may determine that all write commands stored in the write area table do not overlap the read command received from the snooping circuit 212. Because the read command received from the snooping circuit 212 does not overlap the write command stored in the write area table, the hazard filter 213 may transmit the read command received from the snooping circuit 212 to the memory controller 220.

The hazard filter 213 may store the read command received from the snooping circuit 212 in the read mark table. Referring to FIG. 7, the hazard filter 213 may change the value of the validity information from 0 to 1 as the read command is stored. Referring to FIG. 7, the value of the tag of the read command, 0x45, may be stored in the tag column of the read mark table. Referring to FIG. 7, a value of 0 indicating that the read command received from the snooping circuit 212 has been transmitted to the memory controller 220 may be stored in the mark column of the read mark table.

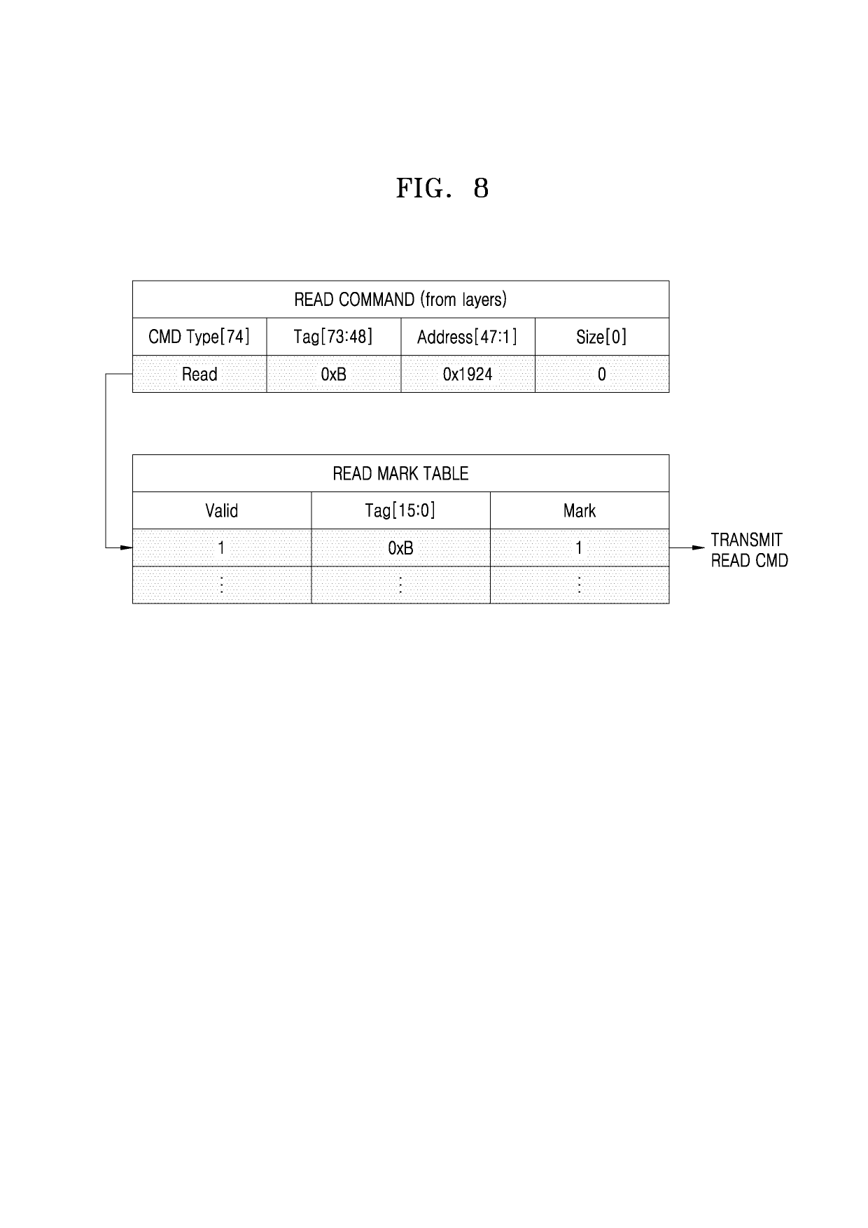

FIG. 8 is a diagram illustrating an operation when the hazard filter 213 receives a read command determined to overlap a write command from a plurality of layers, according to an embodiment.

Referring to FIG. 8, an example of a read command received from the plurality of layers 211 and the read mark table stored in the hazard filter 213 is illustrated.

Referring to FIG. 8, a tag of the read command may have a value of 0xB, an address of the read command may have a value of 0x1924, and a size of the read command may have a value of 0.

When the hazard filter 213 receives a read command from the plurality of layers 211, the hazard filter 213 may compare the read command received from the plurality of layers 211 with the read command stored in the read mark table to determine whether the read command received from the plurality of layers 211 has been transmitted to the memory controller 220.

Referring to FIG. 8, the hazard filter 213 may search the read mark table for a read command having a tag identical to 0xB, which is the tag of the read command received from the plurality of layers 211.

The hazard filter 213 may determine whether the read command received from the plurality of layers 211 has been transmitted to the memory controller 220, based on the value of a mark corresponding to the read command having the tag identical to 0xB, which is the tag of the read command received from the plurality of layers 211. Referring to FIG. 8, based on the value of the mark corresponding to the read command having the tag of 0xB being 1, the hazard filter 213 may determine that the read command received from the plurality of layers 211 has not been transmitted to the memory controller 220. Accordingly, the hazard filter 213 may transmit the read command received from the plurality of layers 211 to the memory controller 220.

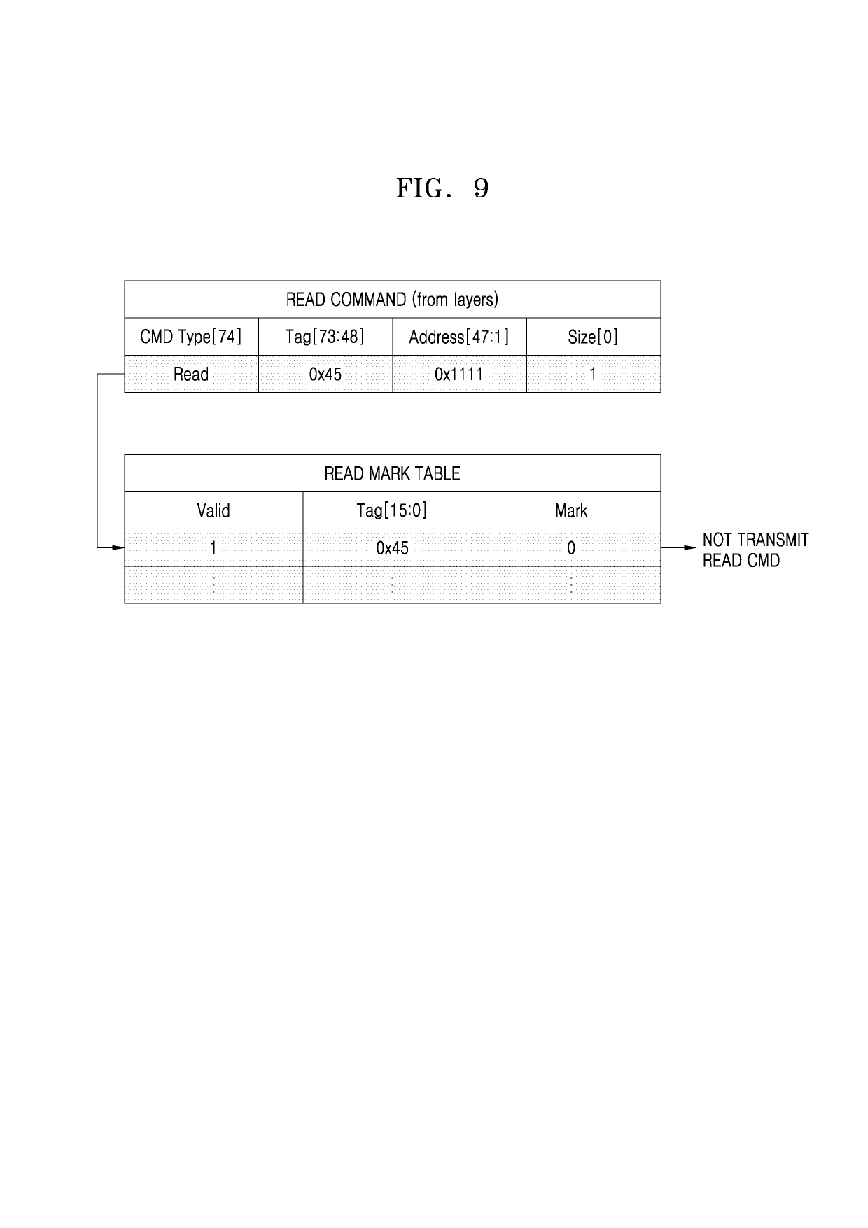

FIG. 9 is a diagram illustrating an operation when the hazard filter 213 receives a read command that is determined not to overlap a write command from a plurality of layers, according to an embodiment.

Referring to FIG. 9, an example of a read command received from the plurality of layers 211 and the read mark table stored in the hazard filter 213 is illustrated.

As shown in FIG. 9, a tag of the read command may have a value of 0x45, an address of the read command may have a value of 0x1111, and a size of the read command may have a value of 1.

The hazard filter 213 may search the read mark table for a read command having a tag identical to 0x45, which is the tag of the read command received from the plurality of layers 211.

Based on the value of the mark corresponding to the read command with the tag 0x45 being 0, the hazard filter 213 may determine that the read command received from the plurality of layers 211 has been transmitted to the memory controller 220. Accordingly, the hazard filter 213 may not transmit the read command received from the plurality of layers 211 to the memory controller 220.

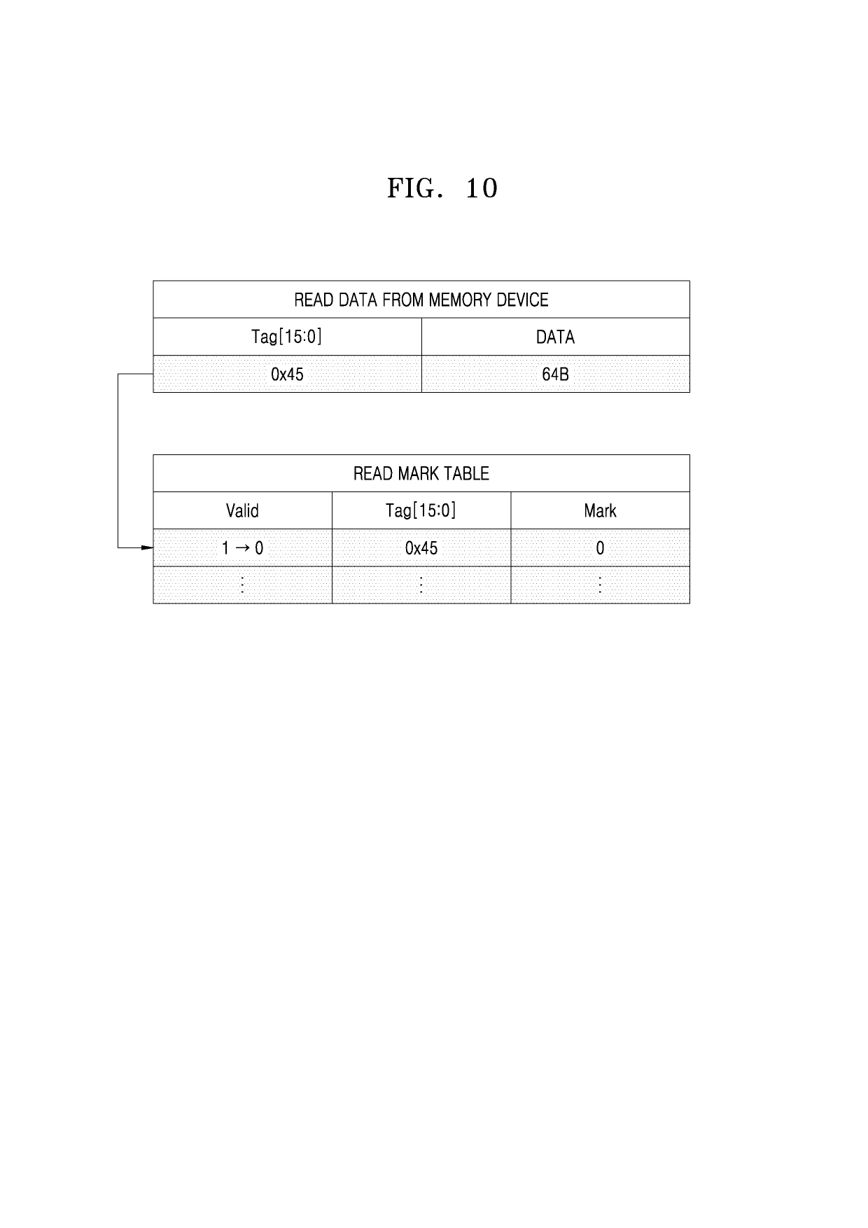

FIG. 10 is a diagram illustrating an operation of the hazard filter 213 when data is received from the memory device 300, according to an embodiment.

Referring to FIG. 10, an example of read data received from the memory device 300 and the read mark table stored in the hazard filter 213 is illustrated.

The read data received from the memory device 300 may include a tag and data. The tag of the read data may indicate the tag of the read command corresponding to the read data.

Referring to FIG. 10, the tag of the read data may have a value of 0x45, and the read data may have data of 64 bytes in size.

When the hazard filter 213 receives the read data from the memory device 300, the hazard filter 213 may delete a read command corresponding to the read data received from the memory device 300, from the read mark table.

The hazard filter 213 may search the read mark table for the read command having a tag identical to 0x45, which is the tag of read data received from the memory device 300.

The hazard filter 213 may delete the read command having the tag identical to 0x45, which is the tag of read data received from the memory device 300, from the read mark table. Here, the hazard filter 213 may delete the read command with the tag 0x45 from the read mark table by changing the value of the validity bit corresponding to 0x45, which is the same tag as that of the read data received from the memory device 300, from 1 to 0.

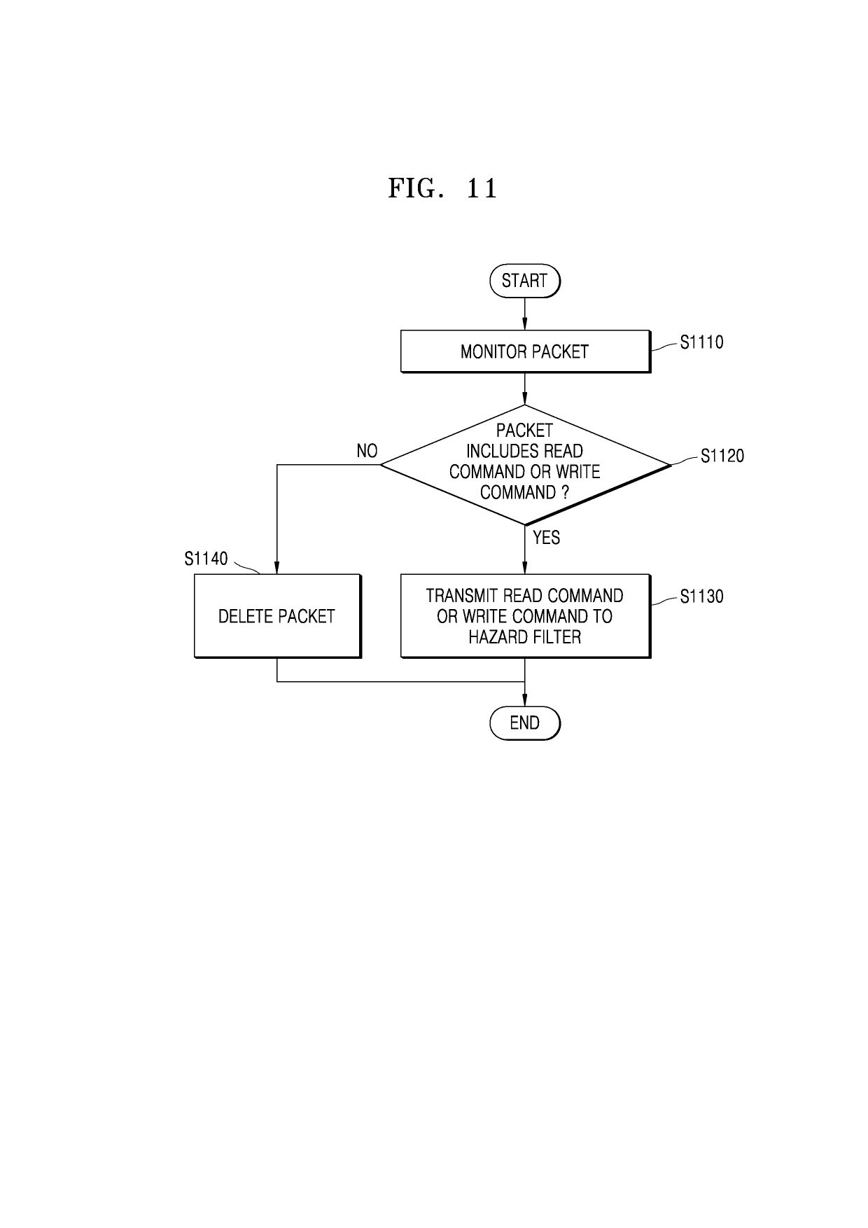

FIG. 11 is a flowchart illustrating an operating method of the snooping circuit 212 included in the memory interface 210 of the memory expander 200 according to an embodiment.

Referring to FIG. 11, in operation S1110, the snooping circuit 212 of the memory interface 210 may monitor a packet received from the host device 100. The snooping circuit 212 may monitor a packet that has passed through the first layer 211_1 among the plurality of layers 211 in which decoding of the packets is performed.

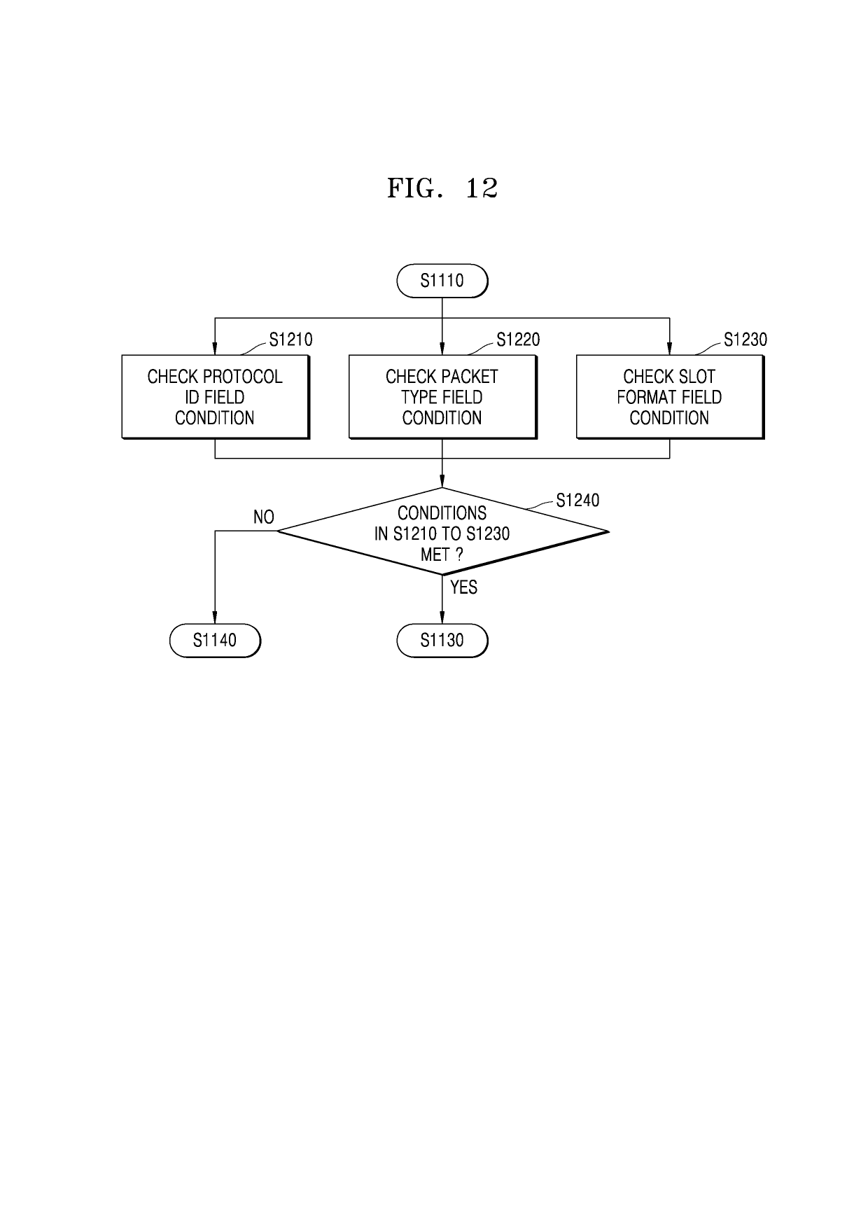

In operation S1120, the snooping circuit 212 of the memory interface 210 may determine whether the packet includes a read command or a write command. The snooping circuit 212 may determine whether the packet includes a read command or a write command, based on a protocol ID field, a packet type field, and a slot format field included in the packet. A method of operation S1120 is described below with reference to FIG. 12.

If it is determined that the packet includes a read command or a write command, the process may proceed to operation S1130, in which the snooping circuit 212 may transmit the read command or the write command to the hazard filter 213. That is, the snooping circuit 212 may transmit the read command or the write command included in the packet to the hazard filter 213 by bypassing the second to fifth layers 211_2 to 211_5 among the plurality of layers 211.

If it is determined that the packet does not include a read command or a write command, the process may proceed to operation S1140, in which the snooping circuit 212 may delete the monitored packet within the snooping circuit 212.

FIG. 12 is a flowchart illustrating a method by which a snooping device determines whether a packet includes a read command or a write command, according to an embodiment.

Referring to FIG. 12, in operation S1210, the snooping circuit 212 of the memory interface 210 may check a protocol ID field condition. The snooping circuit 212 may determine whether the protocol ID field indicates that the packet is a memory packet.

In operation S1220, the snooping circuit 212 of the memory interface 210 may check the packet type field condition. The snooping circuit 212 may determine whether the packet type field indicates that the packet is a protocol packet.

In operation S1230, the snooping circuit 212 of the memory interface 210 may check a slot format field condition. The snooping circuit 212 may determine whether the slot format field indicates a read command or a write command.

Here, the snooping circuit 212 may perform operations S1210 to S1230 in parallel. That is, the snooping circuit 212 may perform operations S1210 to S1230 simultaneously, thereby reducing the delay time occurring in the snooping circuit 212.

In operation S1240, the snooping circuit 212 of the memory interface 210 may determine whether all of the conditions in operations S1210 to S1230 are met. If it is determined that the protocol ID field indicates that the packet is a memory packet in operation S1210, if it is determined that the packet type field indicates that the packet is a protocol packet in operation S1220, and if it is determined that the slot format field indicates a read command or a write command in operation S1230, the snooping circuit 212 may determine that all of the conditions in operations S1210 to S1230 are met.

If it is determined that all of the conditions are met in operations S1210 to S1230, the snooping circuit 212 may proceed to operation S1130 of FIG. 11.

Conversely, if it is determined that any (i.e., one or more) of the conditions in operations S1210 to S1230 is not met, the snooping circuit 212 may proceed to operation S1140 of FIG. 11.

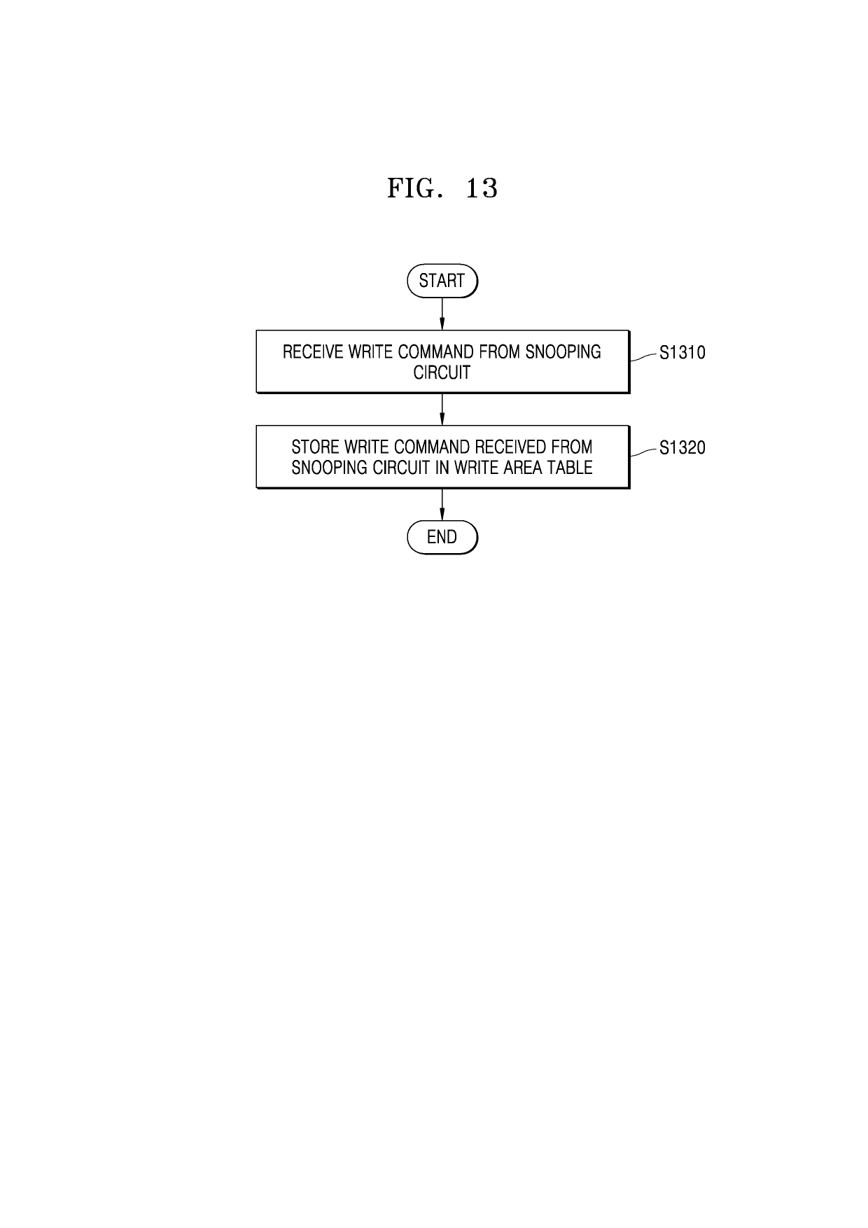

FIG. 13 is a flowchart illustrating an operating method when the hazard filter 213 included in the memory interface 210 of the memory expander 200 receives a write command from the snooping circuit 212, according to an embodiment.

Referring to FIG. 13, in operation S1310, the hazard filter 213 may receive a write command from the snooping circuit 212. Here, the write command received from the snooping circuit 212 may be a write command that has bypassed at least some of the plurality of layers 211.

In operation S1320, the hazard filter 213 may store the write command received from the snooping circuit 212 in the write area table. The hazard filter 213 may change the value of the validity information from 0 to 1 and store the tag, address, and size included in the write command as the tag, address, and size of the write area table.

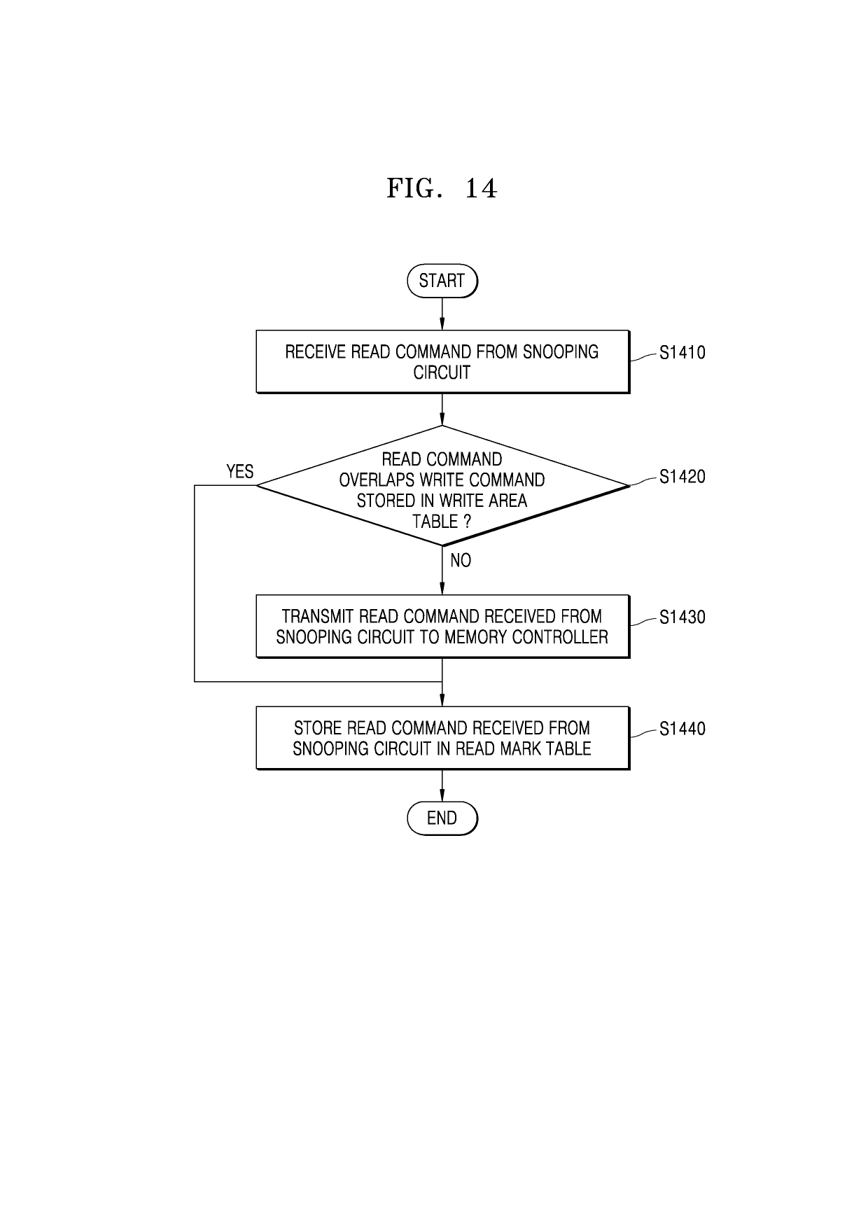

FIG. 14 is a flowchart illustrating an operating method when the hazard filter 213 included in the memory interface 210 of the memory expander 200 receives a read command from the snooping circuit 212, according to an embodiment.

Referring to FIG. 14, in operation S1410, the hazard filter 213 may receive a read command from the snooping circuit 212. Here, the read command received from the snooping circuit 212 may be a read command that has bypassed at least some of the plurality of layers 211.

In operation S1420, the hazard filter 213 may determine whether the read command received from the snooping circuit 212 overlaps a write command stored in the write area table. The hazard filter 213 may compare an address and size corresponding to the read command received from the snooping circuit 212 with the address and size corresponding to the write command stored in the write area table to determine whether the read command received from the snooping circuit 212 overlaps the write command stored in the write area table.

If it is determined that the read command received from the snooping circuit 212 does not overlap the write command stored in the write area table, the process proceeds to operation S1430, in which the hazard filter 213 may transmit the read command received from the snooping circuit 212 to the memory controller 220.

Conversely, if it is determined that the read command received from the snooping circuit 212 overlaps the write command stored in the write area table, the hazard filter 213 may proceed directly to operation S1440 without transmitting the read command received from the snooping circuit 212 to the memory controller 220.

In operation S1440, the hazard filter 213 may store the read command received from the snooping circuit 212 in the read mark table. The hazard filter 213 may change the value of the validity information from 0 to 1, store the tag included in the read command as a tag of the read mark table, and set a mark value depending on whether the read command received from the snooping circuit 212 has been transmitted to the memory controller 220.

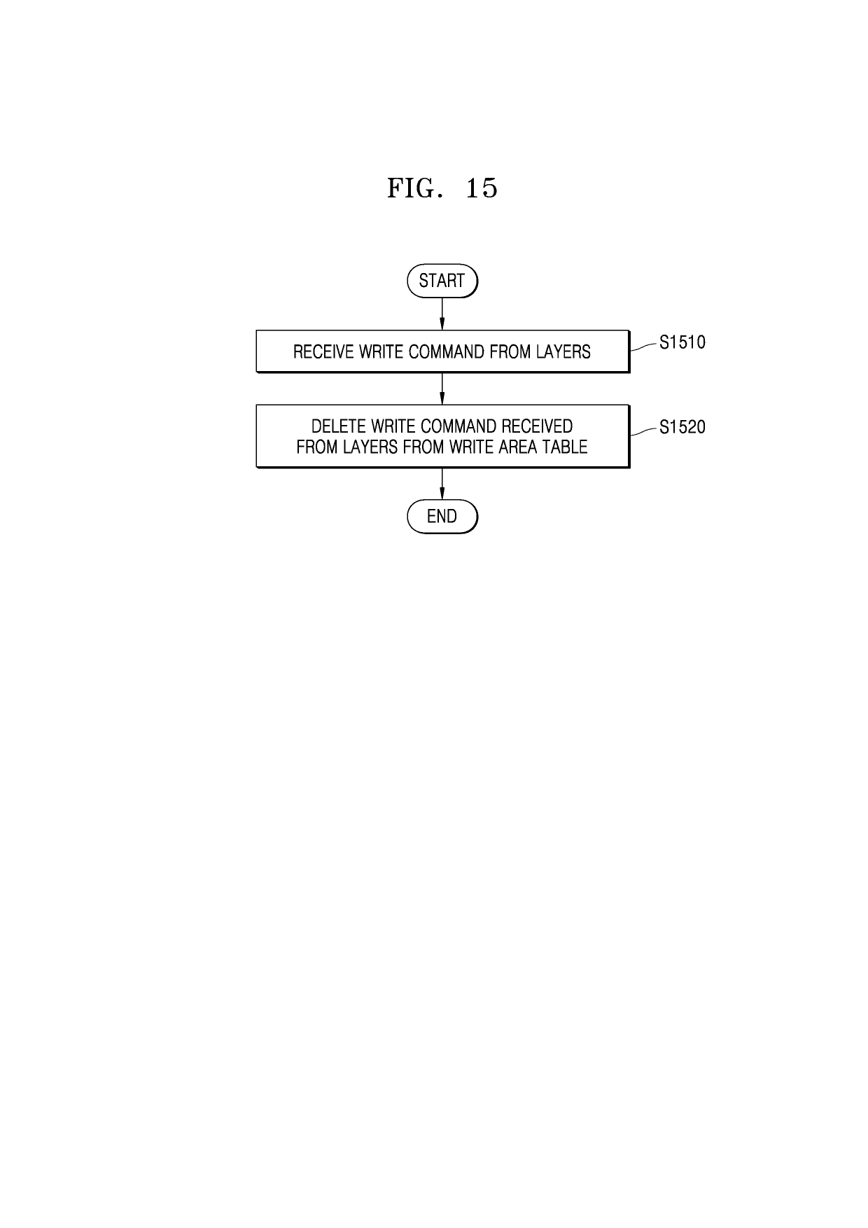

FIG. 15 is a flowchart illustrating an operating method when the hazard filter 213 included in the memory interface 210 of the memory expander 200 receives a write command from a plurality of layers, according to an embodiment.

Referring to FIG. 15, in operation S1510, the hazard filter 213 may receive a write command from the plurality of layers 211.

In operation S1520, the hazard filter 213 may delete the write command received from the plurality of layers 211 from the write area table. The hazard filter 213 may delete the write command received from the plurality of layers 211 from the write area table by changing the value of the validity bit corresponding to the write command having the same tag as that of the write command received from the plurality of layers 211 from 1 to 0.

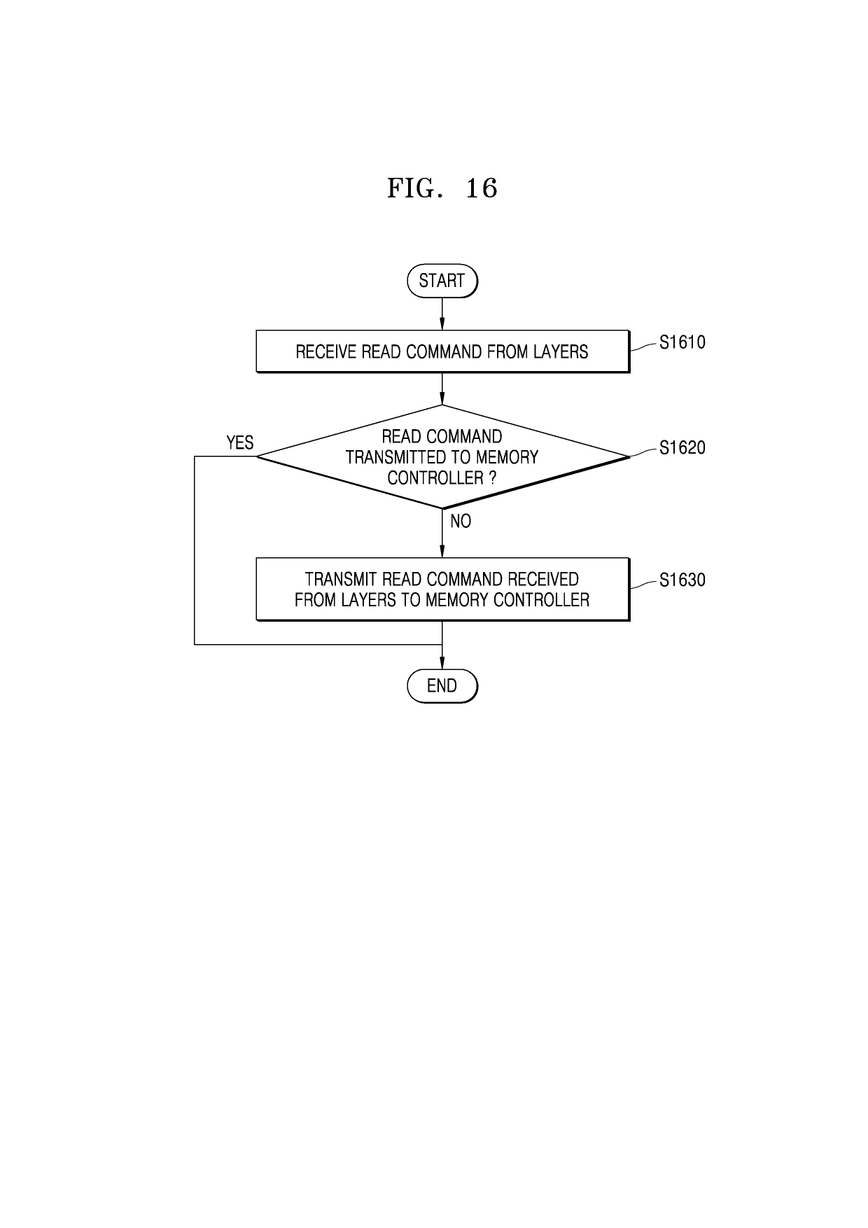

FIG. 16 is a flowchart illustrating an operating method when the hazard filter 213 included in the memory interface 210 of the memory expander 200 receives a read command from a plurality of layers, according to an embodiment.

Referring to FIG. 16, in operation S1610, the hazard filter 213 may receive a read command from the plurality of layers 211.

In operation S1620, the hazard filter 213 may determine whether the read command has been transmitted from the plurality of layers 211 to the memory controller 220. The hazard filter 213 may compare the read command received from the plurality of layers 211 with a read command stored in the read mark table to determine whether the read command received from the plurality of layers 211 has been transmitted to the memory controller 220.

If it is determined that the read command received from the plurality of layers 211 has not been transmitted to the memory controller 220, the process proceeds to operation S1630, in which the hazard filter 213 may transmit the read command received from the plurality of layers 211 to the memory controller 220.

Conversely, if it is determined that the read command received from the plurality of layers 211 has been transmitted to the memory controller 220, the hazard filter 213 may terminate the operation without transmitting the read command received from the plurality of layers 211 to the memory controller 220.

In some embodiments, each of the components represented by a block as illustrated in FIGS. 1 and 2 may be implemented as various numbers of hardware and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of embodiments have been particularly shown and described, it will be understood that various changes in form and details may be made therein without departing from the spirit and scope of the following claims.

What is claimed is:

1. A memory expander comprising:
a memory controller configured to control a memory device; and
a memory interface configured to receive a packet from a host device, control a plurality of layers to sequentially process the packet and transmit a command included in the packet to the memory controller,
wherein the memory interface comprises a snooping circuit configured to, based on the packet including a read command, transmit the read command in the packet to the memory controller by bypassing at least some of the plurality of layers.

2. The memory expander of claim 1, wherein the plurality of layers comprises a first layer configured to perform decoding on the packet, and
wherein the snooping circuit is further configured to monitor the packet passing through the first layer to identify whether the packet includes the read command.

3. The memory expander of claim 2, wherein the snooping circuit is further configured to:
monitor a protocol ID field, a packet type field, and a slot format field in the packet; and
identify the packet includes the read command based on the protocol ID field indicating that the packet is a memory packet, the packet type field indicating that the packet is a protocol packet, and the slot format field indicating the read command.

4. The memory expander of claim 3, wherein the snooping circuit is further configured to identify, in parallel, whether the protocol ID field indicates that the packet is the memory packet, whether the packet type field indicates that the packet is the protocol packet, and whether the slot format field indicates the read command.

5. The memory expander of claim 1, further comprising a hazard filter circuit,
wherein the snooping circuit is further configured to transmit, based on the packet including the read command or a write command, the read command or the write command to the hazard filter circuit, and
wherein the hazard filter circuit is configured to:
based on the write command being received from the snooping circuit, control the write command received from the snooping circuit to be stored in a write area table; and
based on the read command being received from the snooping circuit, identify whether to transmit the read command received from the snooping circuit to the memory controller, based on the write area table.

6. The memory expander of claim 5, wherein the hazard filter circuit is further configured to control, based on the write command being received from the plurality of layers, the write command corresponding to the write command received from the plurality of layers to be deleted from the write area table.

7. The memory expander of claim 5, wherein the hazard filter circuit is further configured to:
based on the read command being received from the snooping circuit, compare an address and a size corresponding to the read command received from the snooping circuit with an address and a size corresponding to the write command stored in the write area table to identify whether the read command received from the snooping circuit overlaps the write command stored in the write area table, and
based on identifying the read command received from the snooping circuit does not overlap the write command stored in the write area table, transmit the read command received from the snooping circuit to the memory controller.

8. The memory expander of claim 7, wherein the hazard filter circuit is further configured to control the read command received from the snooping circuit to be stored in a read mark table, and information indicating whether the read command received from the snooping circuit has been transmitted to the memory controller to be stored in the read mark table.

9. The memory expander of claim 8, the hazard filter circuit is further configured to:
based on the read command being received from the plurality of layers, compare the read command received from the plurality of layers with the read command stored in the read mark table to identify whether the read command received from the plurality of layers has been transmitted to the memory controller, and
based on identifying that the read command received from the plurality of layers has not been transmitted to the memory controller, transmit the read command received from the plurality of layers to the memory controller.

10. The memory expander of claim 8, wherein the hazard filter circuit is further configured to receive error information about the read command or the write command received from the snooping circuit from the plurality of layers and control the write command to be deleted from the write area table or the read command to be deleted from the read mark table, corresponding to the error information.

11. An operating method of a memory expander including a memory controller and a memory interface, the operating method comprising:
receiving a packet from a host device through the memory interface;
monitoring the packet through a snooping circuit included in the memory interface;
identifying whether the packet includes a read command or a write command through the snooping circuit; and
based on identifying the packet includes the read command or the write command, transmitting the read command or the write command to a hazard filter included in the memory interface through the snooping circuit.

12. The method of claim 11, wherein the identifying whether the packet includes the read command or the write command comprises identifying that the packet includes the read command or the write command based on a protocol ID field of the packet indicating that the packet is a memory packet, a packet type field of the packet indicating that the packet is a protocol packet, and a slot format field of the packet indicating the read command or the write command.

13. The method of claim 11, further comprising based on the write command being received from the snooping circuit, storing the write command received from the snooping circuit in a write area table through the hazard filter,.

14. The method of claim 11, further comprising:
based on the read command being received from the snooping circuit, identifying, based on the write area table, whether to transmit the read command received from the snooping circuit to the memory controller through the hazard filter; and
based on identifying to transmit the read command received from the snooping circuit to the memory controller, transmitting the read command received from the snooping circuit to the memory controller through the hazard filter.

15. The method of claim 14, wherein the identifying whether to transmit the read command received from the snooping circuit to the memory controller comprises:
comparing an address and a size corresponding to the read command received from the snooping circuit with an address and a size corresponding to the write command stored in the write area table to identify whether the read command received from the snooping circuit overlaps the write command stored in the write area table; and
based on the read command received from the snooping circuit not overlapping the write command stored in the write area table, identifying to transmit the read command received from the snooping circuit to the memory controller.

16. A computing system comprising:
a host device;
a memory device; and
a memory expander comprising a memory interface configured to receive a packet from the host device and a memory controller configured to control the memory device based on a command included in the packet,
wherein the memory interface is configured to control a plurality of layers to sequentially process the packet, and comprises:
a snooping circuit transmitting a read command or a write command included in the packet by bypassing at least some of the plurality of layers; and
a hazard filter circuit configured to identify, based on the read command being received from the snooping circuit, whether to transmit the read command received from the snooping circuit to the memory controller, based on the write command received from the snooping circuit being stored in a write area table.

17. The computing system of claim 16, wherein circuit is further configured to:
based on the read command being received from the snooping circuit, compare an address and a size corresponding to the read command received from the snooping circuit with an address and a size corresponding to the write command stored in the write area table to identify whether the read command received from the snooping circuit overlaps the write command stored in the write area table, and
based on identifying the read command received from the snooping circuit does not overlap the write command stored in the write area table, transmit the read command received from the snooping circuit to the memory controller.

18. The computing system of claim 17, wherein the hazard filter circuit is further configured to control the read command received from the snooping circuit to be stored in a read mark table and information indicating whether the read command received from the snooping circuit has been transmitted to the memory controller to be stored in the read mark table.

19. The computing system of claim 18, wherein the hazard filter circuit is further configured to:
based on the read command being received from the plurality of layers, compare the read command received from the plurality of layers with the read command stored in the read mark table to identify whether the read command received from the plurality of layers has been transmitted to the memory controller, and
based on identifying that the read command received from the plurality of layers has not been transmitted to the memory controller, transmit the read command received from the plurality of layers to the memory controller.

20. The computing system of claim 16, wherein the hazard filter circuit is further configured to:
based on the write command being received from the snooping circuit, control the write command received from the snooping circuit to be stored in the write area table, and
based on the write command being received from the plurality of layers, control the write command corresponding to the write command received from the plurality of layers to be deleted from the write area table.
